(19) United States
(12) Patent Application Publication
(10) Pub. No.: US 2021/0372062 A1
(43) Pub. Date: Dec. 2, 2021

(54) SPEED BUMP SYSTEM HAVING AN ACTUATABLE SPEED BUMP AND METHOD FOR CONTROLLING AN ACTUATABLE SPEED BUMP

(71) Applicant: Lear Corporation, Southfield, MI (US)

(72) Inventors: Raju KUNDE, Farmington Hills, MI (US); Vamsi PEDDINA, Windsor (CA)

(73) Assignee: Lear Corporation, Southfield, MI (US)

(21) Appl. No.: 15/929,998

(22) Filed: Jun. 2, 2020

(51) Int. Cl. E01F 9/529; G05B 15/02; H04W 4/40

(52) U.S. Cl. CPC E01F 9/529; H04W 4/40; G05B 15/02

(57) ABSTRACT

A speed bump system includes an actuatable speed bump for use with a vehicle roadway, the actuatable speed bump including an element and an actuator configured to move the element between a first position and a second position. The speed bump system also includes a controller configured to receive an input signal including data from a wireless vehicle-to-x communication, the data indicative of a characteristic of a vehicle, and to generate a control signal operative to control the actuator to move the element of the actuatable speed bump between the first and second positions based on the characteristic of the vehicle. A method for controlling an actuatable speed bump is also described.

### TECHNICAL FIELD

The following relates to a speed bump system having an actuatable speed bump and a method for controlling an actuatable speed bump that utilize vehicle-to-x communications.

### BACKGROUND

Speed bumps are commonly used to reduce traffic speeds. However, in many cases speed bumps can cause traffic congestion because heavier vehicles like buses and trucks may slow down, which may cause other lighter vehicles to stop. Such cases can result in uneven traffic flow, increased fuel consumption, and increased emissions.

Another problematic aspect of speed bumps is their effect on emergency vehicles. According to a study by the Institute of Traffic Engineers (ITE) entitled “Traffic Calming Measures—Speed Hump,” dated Mar. 20, 2007, response times for emergency vehicles are slowed by 3-5 seconds per speed bump for fire trucks and fire engines and up to 10 seconds per speed bump for ambulances with patients aboard.

Moreover, there can be an increase in traffic noise from braking and acceleration of vehicles on streets with speed bumps, particularly with buses and trucks. Other negative effects of speed bumps can include wear and tear on vehicle brakes, engine and suspension components.

Vehicle-to-everything or vehicle-to-x (V2X) communication is the passing of information from a vehicle to any entity that may affect the vehicle or its occupants, and vice versa. V2X is a vehicular communication that incorporates or includes other more specific types of communication such as Vehicle-to-Infrastructure (V2I), Vehicle-to-Network (V2N), Vehicle-to-Vehicle (V2V), Vehicle-to-Pedestrian (V2P), and Vehicle-to-Device (V2D). The main motivations for V2X communication are road safety, traffic efficiency, and energy savings, as well as vehicle occupant safety, information, and comfort.

One type of V2X communication technology is Dedicated Short Range Communication (DSRC) Wireless Local Area Network (WLAN) based. Another type of V2X communication technology is cellular based, which may also be referred to as Cellular Vehicle-to-everything (CV2X). V2X communication may use WLAN technology and work directly between vehicles, which form a vehicular ad-hoc network as two V2X transmitters come within each range of each other. Hence it does not necessarily require any infrastructure for vehicles to communicate, which is key to assure safety in remote or little developed areas.

A Vehicle equipped with V2X communication technology may transmit/receive messages containing vehicle data such as speed, heading, type, etc. These messages are created from the standards provided by the facility layer. The standard messages are Cooperative Awareness Messages (CAM) and Decentralized Environmental Notification Messages (DENM) per the European Telecommunications Standards Institute (ETSI) and Basic Safety Message (BSM) per the Society of Automotive Engineers (SAE) J2735 standard. The data volume of these messages is very low. The radio technology could be any of WLAN based IEEE 802.11p standards developed by the Institute of Electrical and Electronics Engineers (IEEE) or cellular based PC5 interface.

To overcome the problems described above associated with conventional speed bumps, a need exists for a speed bump system having an actuatable speed bump and a method for controlling an actuatable speed bump that utilize such wireless V2X communications. Such a system and method would control a position of the actuatable speed bump based on a characteristic of a vehicle, such as vehicle speed, type, or heading, utilizing data from a wireless V2X communication indicative of the characteristic of the vehicle.

### SUMMARY

According to one non-limiting exemplary embodiment described herein, a speed bump system is provided. The speed bump system may comprise an actuatable speed bump for use with a vehicle roadway, the actuatable speed bump comprising an element and an actuator configured to move the element between a first position and a second position. The speed bump system may further comprise a controller configured to receive an input signal comprising data from a wireless vehicle-to-x communication, the data indicative of a characteristic of a vehicle, and to generate a control signal operative to control the actuator to move the element of the actuatable speed bump between the first and second positions based on the characteristic of the vehicle.

According to another non-limiting exemplary embodiment described herein, a method is provided for controlling an actuatable speed bump for use with a vehicle roadway, the actuatable speed bump comprising an element and an actuator configured to move the element between a first position and a second position. The method may comprise receiving an input signal comprising data from a wireless vehicle-to-x communication, the data indicative of a characteristic of a vehicle, and controlling the actuator to move the element of the actuatable speed bump between the first and second positions based on the characteristic of the vehicle.

A detailed description of these and other non-limiting exemplary embodiments of a speed bump system having an actuatable speed bump and a method for controlling an actuatable speed bump that utilize vehicle-to-x communications is set forth below together with the accompanying drawings.

### BRIEF DESCRIPTION OF THE DRAWINGS

FIG. 1 is simplified block diagram of a vehicle equipped for V2X communication for use with non-limiting exemplary embodiments of a speed bump system and method for controlling an actuatable speed bump according to the present disclosure;

FIG. 2 is an illustration of one example of V2X communication for use in non-limiting exemplary embodiments of a speed bump system and method for controlling an actuatable speed bump according to the present disclosure;

FIG. 3 is a simplified block diagram of a non-limiting exemplary embodiment of a speed bump system and method for controlling an actuatable speed bump according to the present disclosure; and

FIGS. 4A and 4B are simplified block diagrams showing cross-sectional views of a non-limiting exemplary embodiment of an actuatable speed bump for the speed bump system and method for controlling an actuatable speed bump according to the present disclosure.

### DETAILED DESCRIPTION

As required, detailed non-limiting embodiments are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

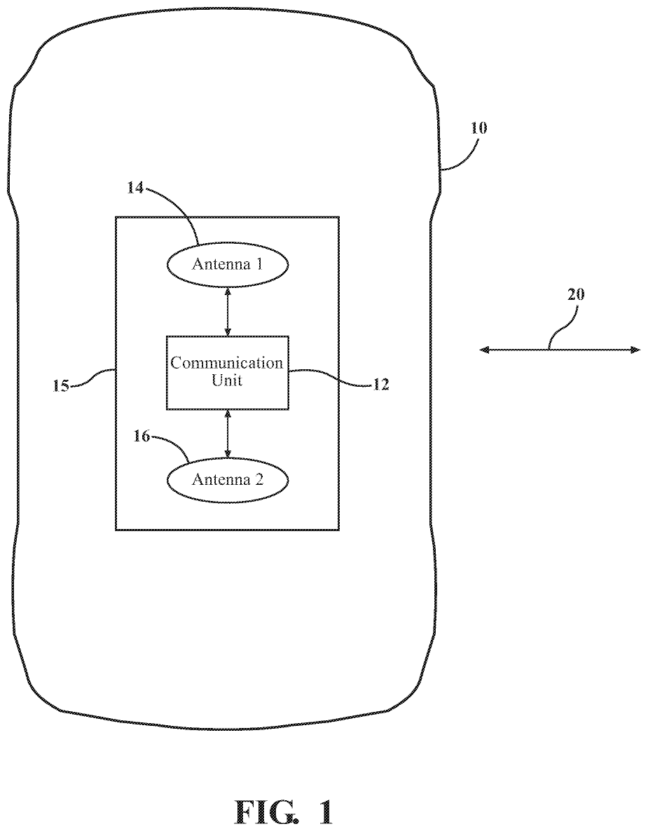

With reference to FIGS. 1-3, a more detailed description of non-limiting exemplary embodiments of a speed bump system having actuatable speed bump and a method for controlling an actuatable speed bump that utilize vehicle-to-x communications will be provided. For ease of illustration and to facilitate understanding, like reference numerals may be used herein for like components and features throughout the drawings.

As previously described speed bumps are commonly used to reduce traffic speeds but can cause traffic congestion because heavier vehicles like buses and trucks may slow down, which may cause other lighter vehicles stop and result in uneven traffic flow, increased fuel consumption, and increased emissions. Speed bumps can also lead to increased response times for emergency vehicles. There can also be an increase in traffic noise from braking and acceleration of vehicles on streets with speed bumps, particularly with buses and trucks. Other negative effects of speed bumps can include wear and tear on vehicle brakes, engine and suspension components.

As also previously described, vehicle-to-everything (V2X) communication is the passing of information from a vehicle to any entity that may affect the vehicle, and vice versa. V2X is a vehicular communication that incorporates or includes other more specific types of communication such as Vehicle-to-Infrastructure (V2I), Vehicle-to-Network (V2N), Vehicle-to-Vehicle (V2V), Vehicle-to-Pedestrian (V2P), and Vehicle-to-Device (V2D). V2X communication is designed to improve road safety, traffic efficiency, and energy savings, as well as vehicle occupant safety, information, and comfort, and may be implemented using Dedicated Short Range Communication (DSRC) Wireless Local Area Network (WLAN) technology, or cellular technology, which may also be referred to as Cellular Vehicle-to-everything (CV2X). V2X communication may use WLAN technology and work directly between vehicles, which form a vehicular ad-hoc network as two V2X transmitters come within each range of each other. Hence it does not require any infrastructure for vehicles to communicate, which can improve safety in remote or little developed areas. A Vehicle equipped with V2X communication technology may transmit/receive messages containing vehicle data such as speed, heading, type, etc. These messages are created from the standards provided by the facility layer. The standard messages are Cooperative Awareness Messages (CAM) and Decentralized Environmental Notification Messages (DENM) per the European Telecommunications Standards Institute (ETSI) and Basic Safety Message (BSM) per the Society of Automotive Engineers (SAE) J2735 standard. The data volume of these messages is very low. The radio technology could be any of WLAN based IEEE 802.11p standards developed by the Institute of Electrical and Electronics Engineers (IEEE) or cellular based PC5 interface.

The present disclosure provides a speed bump system having an actuatable speed bump and a method for controlling an actuatable speed bump that utilize wireless V2X communications to overcome the problems described above associated with conventional speed bumps. The system and method of the present disclosure control a position of the actuatable speed bump based on a characteristic of a vehicle, such as vehicle speed, type, or heading, utilizing data from a wireless V2X communication indicative of the characteristic of the vehicle.

The system and method of the present disclosure solve the problems stated and ensures traffic safety for all. The system and method of the present disclosure may utilize vehicles connected to each other as well as with infrastructure and that share information wirelessly, such as by using DSRC/Cellular-V2X. The present disclosure provides a smart speed bump with embedded electronic capability, which may be connected to a Road Side Unit (RSU) via a wired or wireless connection. As previously described, a vehicle may be equipped with a V2X On Board Unit (OBU) and may broadcast its vehicle data comprising information such as position, speed, heading and other information 10 times per second. According to the present disclosure, a Road Side Unit (RSU) may receive the broadcast message from approaching vehicles and decide whether to flatten or raise a speed bump. For example, if an approaching vehicle has a speed more than the designated speed limit, then the RSU may trigger to raise the speed bump. Alternatively, if the approaching vehicles has a speed within the designated speed limit, then the RSU may flatten the speed bump.

Although dynamic speed bumps could be provided using traditional sensors such as radar, one advantage of using connected V2X communications according to the present disclosure is that, if a vehicle approaches the speed bump with a speed greater than the designated speed limit, the RSU may in response broadcast a signal with information regarding the state of the speed bump (e.g., raised/flattened) to the approaching vehicle as well as to other vehicles approaching the speed bump so that such vehicles can slow down to create and/or ensure a free traffic flow.

The present disclosure thus provides a connected smart speed bump as opposed to a conventional speed bump. Moreover, using V2X communications in a dynamic speed bump rather than radar to determine or calculate the speed of approaching vehicles eliminates road construction that may be needed to install radar. The connected, smart speed bump of the present disclosure also provides advantages such as data collection which can be used for further enhancement of applications, elimination or reduction of uneven traffic flow, improved fuel consumption, decreased emissions, as well as decreased wear and tear on brakes, engines and suspension components.

Moreover, since the speed bump is connected, all the data of passing vehicles and the state of the speed bump (e.g., raised/flattened) can be collected and analyzed for future use cases. Still further, as previously described, one problematic aspect of speed bumps is that they slow response times for emergency or public safety vehicles. Advantageously, V2X standard messages support public safety vehicle types. As a result, according to the system and method of the present disclosure, an RSU may receive the BSMs of an approaching vehicles and use the information provided by the BSMs to determine or identify whether any such vehicle is a public safety vehicle, such as an emergency vehicle, fire engine, police, etc. In the event that the approaching vehicle is public safety vehicle, the RSU can trigger the speed bump to flatten, thereby improving the public safety vehicle response time.

Referring now to FIG. 1, a simplified block diagram is shown of a vehicle equipped for V2X communication for use with non-limiting exemplary embodiments of a speed bump system and method for controlling an actuatable speed bump according to the present disclosure. As seen therein, a vehicle 10 may comprise a communication unit 12 for providing V2X communication. The communication unit 12 may be provided in communication with a first antenna 14 (Antenna 1) for wireless DSRC V2X communication and a second antenna 16 (Antenna 2) for wireless cellular V2X communication. Alternatively, both the first antenna 14 and the second antennas 16 could be antennas for wireless DSRC V2X communication, or antennas for wireless cellular V2X communication, or a combination of both. Such communication between the communication unit 12 and the first and second antennas 14, 16 may be provided over any suitable vehicle bus. The communication unit 12 and antennas 14, 16 may be provided as part of an On-Board Unit (OBU) 15 for V2X communication.

The communication unit 12 of the vehicle 10 may be configured to enable and control wireless V2X communication between the vehicle 10 and other similarly equipped vehicles (i.e., V2V communication) or between the vehicle 10 and another node or device (e.g., Vehicle-to-Infrastructure (V2I) communication, Vehicle-to-Network (V2N) communication, Vehicle-to-Pedestrian (V2P) communication, or Vehicle-to-Device (V2D) communication). Such V2X communication may be accomplished utilizing radio frequency signals 20 for transmission of data according to known techniques, protocols, and/or standards associated with such communication. In that regard, the first and/or second antennas 14, 16 of the vehicle 10 may be configured for transmitting and receiving DSRC WLAN or cellular radio frequency signals.

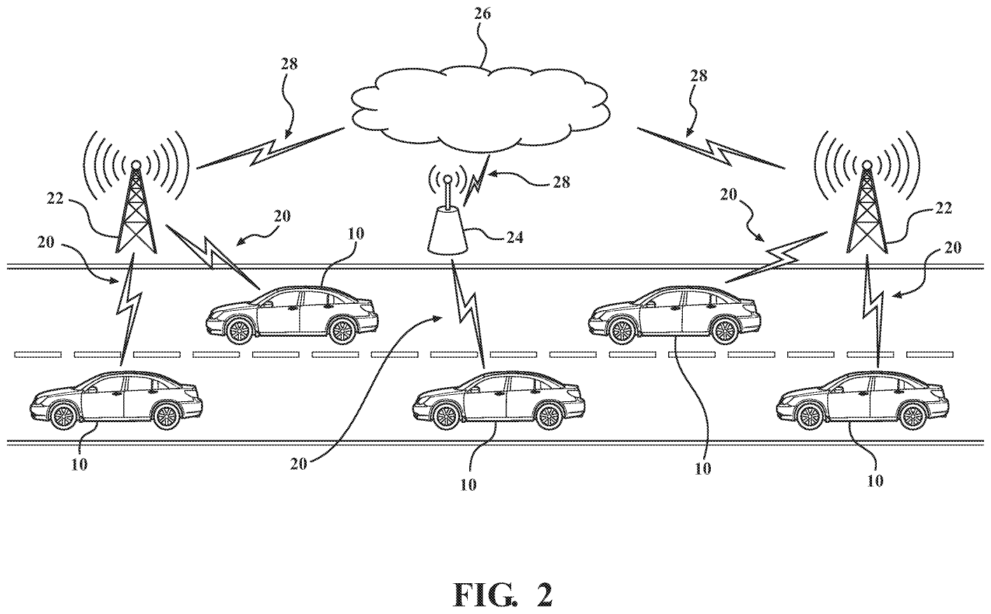

Referring next to FIG. 2, an illustration is shown of one example of V2X communication for use in non-limiting exemplary embodiments of a speed bump system and method for controlling an actuatable speed bump according to the present disclosure. As seen therein, and with continuing reference to FIG. 1, the communication units 12 of the vehicles 10 may be configured to enable and control wireless V2X communication 20 between the vehicle 10 and a node or device such as an infrastructure transmitter/receiver, which may be a cellular base station 22 or a roadside unit (RSU) 24 (e.g., Vehicle-to-Infrastructure (V2I) communication, Vehicle-to-Network (V2N) communication, or Vehicle-to-Device (V2D) communication). In that regard, the infrastructure transmitter/receiver, such as the cellular base station 22 and/or the roadside unit (RSU) 24 may also be configured for communication with each other over ad-hoc or established networks, such as the internet 26, which communication may be wireless communications 28, wired communications (not shown), or a combination of both.

Once again, such V2X communication may be accomplished utilizing radio frequency signals for transmission of data according to known techniques, protocols, and/or standards associated with such communication. The first and/or second antennas 14, 16 of the vehicles 10 may be configured for transmitting and receiving DSRC WLAN or cellular radio frequency signals. As previously noted, the communication units 12 of the vehicles 10 may also be configured to enable and control wireless V2X communication between the vehicles 10 (i.e., V2V communication (not shown)).

As previously described, the wireless V2X communication 20 may comprise, for example, a Vehicle-to-Infrastructure (V2I) communication, a Vehicle-to-Vehicle (V2V) communication, a Vehicle-to-Pedestrian (V2P) communication, a Vehicle-to-Network (V2N) communication, or a Vehicle-to-Device (V2D) communication. As al so previously described, the wireless V2X communication 20 may comprise a Dedicated Short Range Communication (DSRC) signal or a cellular communication signal. It should also be noted that, as used herein, the term wireless V2X communication refers to any type of wireless vehicle communication or signal to/from anything or to/from any type of destination/origin (e.g., infrastructure, vehicle, pedestrian, network, device, etc.) according to or implemented in any type of communication system.

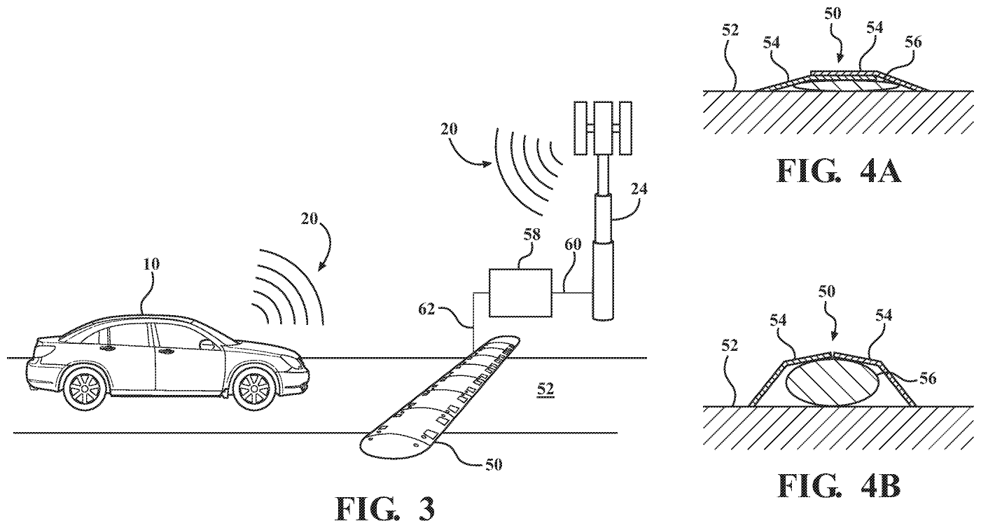

FIG. 3 is a simplified block diagram of a non-limiting exemplary embodiment of a speed bump system and method for controlling an actuatable speed bump according to the present disclosure. FIGS. 4A and 4B are simplified block diagrams showing cross-sectional views of a non-limiting exemplary embodiment of an actuatable speed bump for the speed bump system and method for controlling an actuatable speed bump according to the present disclosure.

As seen therein, the speed bump system may comprise an actuatable speed bump 50 for use with a vehicle roadway 52. In that regard, the roadway 52 may be of any type, such as any type of public or private street, including residential. Such a roadway 52 may comprise one lane or multiple lanes designated for one-way or two-way traffic, a parking lot lane or lanes, or any other type of roadway designated for vehicle travel where a speed bump may be utilized or advantageous.

The actuatable speed bump 50 may comprising an element 54 and an actuator 56 configured to move the element 54 between a first position (FIG. 4A) and a second position (FIG. 4B). It should be noted that the element 54 and the actuator 56 may each be of any known type. As seen in FIGS. 4A and 4B, the element 54 may for example comprise one or more articulated or jointed members which may be hinged at the surface of the roadway 52. As also seen therein, the actuator 56 may for example comprise a bladder configured for inflation and deflation using air or any type of gas or fluid. Alternatively, however, the actuator 56 may comprise one or more actuatable pistons configured to move the element 54 between a first position and a second position.

As seen FIG. 4A, when the actuator 56 is deflated, the element 54 may be positioned, arranged, or moved in or to a first position in which the actuatable speed bump 50 is flattened, retracted, inactive, deactivated, or otherwise positioned or located such that the speed bump 50 does not or does not significantly inhibit the speed of a vehicle 10 traversing the speed bump 50 when the speed bump 50 is arranged or located in a roadway 52. Alternatively, as seen in FIG. 4B, when the actuator 56 is inflated, the element 54 may be positioned, arranged, or moved in or to a second position in which the actuatable speed bump 50 is extended, deployed, active, activated, or otherwise positioned or located such that the speed bump 50 inhibits the speed of a vehicle 10 traversing the speed bump 50, particularly a vehicle traveling at a speed above a threshold value or causes a vehicle or vehicle driver to reduce speed in order to traverse the speed bump 50. Once again, the actuatable speed bump 50, including the element 54 and actuator 56, may be of any known type, such as for example a retractable/extendable speed bump comprising an element that may be substantially retracted by an actuator beneath a surface of a roadway in or to a first position in which the speed bump does not or does not significantly inhibit the speed of a vehicle and may be extended by an actuator to a second position in which the speed bump inhibits the speed of a vehicle.

The speed bump system may further comprise a controller 58 configured to receive an input signal 60 comprising data from a wireless V2X communication 20, wherein the data may be indicative of a characteristic of a vehicle 10. In that regard, the controller 58 may be provided in wired or wireless electrical communication with a roadside unit (RSU) 24. The controller 58 may likewise be provided in wired or wireless electrical communication with the actuatable speed bump 50. While shown in FIG. 3 as separate from the speed bump 50 and/or the roadside unit (RSU) 24, it should be noted that the controller 58 may alternatively be provided as part of the roadside unit (RSU) 24 or the speed bump 50, or may be located proximate the roadside unit (RSU) 24 or speed bump 50.

It should also be noted that the input signal 60 comprising data indicative of a characteristic of the vehicle 10 may alternatively be or comprise the V2X communication 20. Still further, the speed bump system may further comprise a communication unit configured to receive the wireless V2X communication 20. In that regard, the communication unit may be part of the roadside unit (RSU) 24, the controller 58, or the actuatable speed bump 50 and/or may be provided separate therefrom and/or in communication therewith. As well, the communication unit may be configured to broadcast a wireless V2X communication comprising data indicative of the element 54 of the actuatable speed bump 50 having the first position or the second position to the vehicle 10 and/or other vehicles (not shown) traversing the roadway 52.

The controller 58 may be further configured to generate a control signal 62 operative to control the actuator 56 to move the element 54 between the first and second positions based on the characteristic of the vehicle 10. In that regard, the characteristic of the vehicle 10 may comprise a vehicle speed and the control signal 62 may be operative control the actuator 56 to move the element 54 of the actuatable speed bump 50 from the first position to the second position in response to the vehicle speed exceeding a threshold speed. That is, if the vehicle 10 approaches the speed bump 50 at a speed exceeding a threshold (e.g., the designated speed limit for the roadway 52), the speed bump 50 is or will be extended, deployed, active, activated, or otherwise positioned or located such that the speed bump 50 inhibits the speed of a vehicle 10 when traversing the speed bump 50.

Alternatively, where the characteristic of the vehicle 10 comprises a vehicle speed, the control signal 62 may be operative to control the actuator 56 to move the element 54 of the actuatable speed bump 50 from the second position to the first position in response to the vehicle speed failing to exceed a threshold speed. That is, if the vehicle 10 approaches the speed bump 50 at a speed equaling or less than a threshold (e.g., the designated speed limit for the roadway 52), the speed bump 50 is or will be flattened, retracted, inactive, deactivated, or otherwise positioned or located such that the speed bump 50 does not or does not significantly inhibit the speed of the vehicle 10 when traversing the speed bump 50.

The characteristic of the vehicle 10 may alternatively comprise a vehicle type and the control signal 62 may be operative to control the actuator 56 to move the element 54 of the actuatable speed bump 50 from the first position to the second position in response to the vehicle type comprising a private vehicle. That is, if the vehicle 10 approaching the speed bump 50 is a private vehicle (e.g., not a public safety vehicle such as a fire or police department vehicle), the speed bump 50 is or will be extended, deployed, active, activated, or otherwise positioned or located such that the speed bump 50 inhibits the speed of a vehicle 10 when traversing the speed bump 50.

Alternatively, where the characteristic of the vehicle 10 comprises a vehicle type, the control signal 60 may be operative to control the actuator 56 to move the element 54 of the actuatable speed bump 50 from the second position to the first position in response to the vehicle type comprising a public safety vehicle. That is, if the vehicle 10 approaching the speed bump 50 is a public safety vehicle (e.g., a fire or police department vehicle), the speed bump 50 is or will be flattened, retracted, inactive, deactivated, or otherwise positioned or located such that the speed bump 50 does not or does not significantly inhibit the speed of the vehicle 10 when traversing the speed bump 50.

The characteristic of the vehicle 10 may alternatively comprise a vehicle heading and the control signal 62 may be operative to control the actuator 56 to move the element 54 of the actuatable speed bump 50 from the first position to the second position in response to the vehicle heading having a first value or falling within a first range. That is, if the vehicle 10 approaches the speed bump 50 from a first direction, or having a first direction of travel or heading, the speed bump 50 is or will be extended, deployed, active, activated, or otherwise positioned or located such that the speed bump 50 inhibits the speed of a vehicle 10 when traversing the speed bump 50.

Alternatively, where the characteristic of the vehicle 10 comprises a vehicle heading, the control signal 60 may be operative to control the actuator 56 to move the element 54 of the actuatable speed bump 50 from the second position to the first position in response to the vehicle heading having a second value or falling within a second range. That is, if the vehicle 10 approaches the speed bump 50 from a second direction, or having a second direction or travel or heading, the speed bump 50 is or will be flattened, retracted, inactive, deactivated, or otherwise positioned or located such that the speed bump 50 does not or does not significantly inhibit the speed of the vehicle 10 when traversing the speed bump 50.

As those skilled in the art will understand, the communication units 12, antennas 14, 16, controller 58, as well as any other controller, control unit, communication unit, system, subsystem, unit, module, interface, sensor, device, component, or the like described herein may individually, collectively, or in any combination comprise appropriate circuitry, such as one or more appropriately programmed processors (e.g., one or more microprocessors including central processing units (CPU)) and associated memory, which may include stored operating system software and/or application software executable by the processor(s) for controlling operation thereof and for performing the particular algorithm or algorithms represented by the various functions and/or operations described herein, including interaction between and/or cooperation with each other. One or more of such processors, as well as other circuitry and/or hardware, may be included in a single Application-Specific Integrated Circuitry (ASIC), or several processors and various circuitry and/or hardware may be distributed among several separate components, whether individually packaged or assembled into a System-on-a-Chip (SoC). The communication units 12, antennas 14, 16, controller 58, and communication unit, may therefore each comprise one or more processors and associated storage media having stored computer executable instructions for performing the particular algorithm or algorithms represented by the various functions and/or operations described herein.

In that regard, and with continuing reference to FIGS. 1-4B, the system and method of the present disclosure may also be implemented by or in a non-transitory computer readable storage medium having stored computer executable instructions for controlling a speed bump system comprising a controller and an actuatable speed bump for use with a vehicle roadway, the speed bump comprising an element and an actuator configured to move the element between a first position and a second position. When executing the stored instructions, as previously described, the controller may be operative to receive or for receiving an input signal comprising data from a wireless V2X communication, the data indicative of a characteristic of a vehicle, and to control or for controlling the actuator to move the element of the actuatable speed bump between the first and second positions based on the characteristic of the vehicle. Moreover, when executing the stored instructions, the controller and/or a communication unit may be operative to receive or for receiving the wireless V2X communication.

In that regard, as also previously described, receiving the wireless V2X communication may comprise receiving the wireless V2X communication at a roadside unit (RSU) associated with the vehicle roadway. Moreover, when executing the stored instructions, the controller and/or a communication unit may be operative to broadcast or for broadcasting a wireless V2X communication comprising data indicative of the element of the actuatable speed bump having the first position or the second position. As described previously, the input signal may be or comprise the wireless vehicle-to-x communication.

As also previously described, the characteristic of the vehicle may comprise a vehicle speed and control of or controlling the actuator to move the element of the actuatable speed bump between the first and second positions based on the characteristic of the vehicle may comprise movement of or moving the element of the actuatable speed bump from the first position to the second position in response to the vehicle speed exceeding a threshold speed. Alternatively, control of or controlling the actuator to move the element of the actuatable speed bump between the first and second positions based on the characteristic of the vehicle may comprise movement of or moving the element of the actuatable speed bump from the second position to the first position in response to the vehicle speed failing to exceed a threshold speed.

Still further, and again as described previously, the characteristic of the vehicle may comprise a vehicle type and control of or controlling the actuator to move the element of the actuatable speed bump between the first and second positions based on the characteristic of the vehicle may comprise movement of or moving the element of the actuatable speed bump from the first position to the second position in response to the vehicle type comprising a private vehicle. Alternatively, control of or controlling the actuator to move the element of the actuatable speed bump between the first and second positions based on the characteristic of the vehicle may comprise movement of or moving the element of the actuatable speed bump from the second position to the first position in response to the vehicle type comprising a public safety vehicle.

As also described previously, the characteristic of the vehicle may comprise a vehicle heading, and control of or controlling the actuator to move the element of the actuatable speed bump between the first and second positions based on the characteristic of the vehicle may comprise movement of or moving the element of the actuatable speed bump from the first position to the second position in response to the vehicle heading having a first value or falling within a first range. Alternatively, control of or controlling the actuator to move the element of the actuatable speed bump between the first and second positions based on the characteristic of the vehicle may comprise movement of or moving the element of the actuatable speed bump from the second position to the first position in response to the vehicle heading having a second value or falling within a second range.

The present disclosure thus describes a speed bump system having an actuatable speed bump and a method for controlling an actuatable speed bump that utilize such wireless V2X communications to overcome the problems described above associated with conventional speed bumps. The system and method of the present disclosure control a position of the actuatable speed bump based on a characteristic of a vehicle, such as vehicle speed, type, or heading, utilizing data from a wireless V2X communication indicative of the characteristic of the vehicle.

As is readily apparent from the foregoing, various non-limiting embodiments of a speed bump system having an actuatable speed bump and a method for controlling an actuatable speed bump that utilize such wireless V2X communications have been described. While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

1. A speed bump system comprising:
an actuatable speed bump for use with a vehicle roadway, the speed bump comprising an element and an actuator configured to move the element between an inactive position and an active position;
a communication unit configured to receive a wireless vehicle-to-x communication from a vehicle traveling on the vehicle roadway and approaching the actuatable speed bump; and
a controller configured to receive an input signal comprising data from the wireless vehicle-to-x communication, the data indicative of a characteristic of the vehicle, and to generate a control signal operative to control the actuator to move the element between the inactive and active positions based on the characteristic of the vehicle;
wherein the characteristic of the vehicle comprises a vehicle type and wherein the control signal is operative to control the actuator to move the element of the actuatable speed bump from the active position to the inactive position in response to the vehicle type of the vehicle approaching the actuatable speed bump comprising a public safety vehicle.

2. (canceled)

3. The system of claim 1 wherein the communication unit is part of a roadside unit associated with the vehicle roadway.

4. The system of claim 1 wherein the communication unit broadcasts a wireless vehicle-to-x communication comprising data indicative of the element of the actuatable speed bump having the first position or the second position.

5. The system of claim 1 wherein the input signal comprises the wireless vehicle-to-x communication.

6. The system of claim 1 wherein the communication unit is further configured to receive a wireless vehicle-to-x communication from a second vehicle traveling on the vehicle roadway and approaching the actuatable speed bump and wherein the controller is further configured to receive an input signal comprising data from the wireless vehicle-to-x communication from the second vehicle, the data indicative of a characteristic of the second vehicle, wherein the characteristic of the second vehicle comprises a vehicle speed and wherein the control signal is operative control the actuator to move the element of the actuatable speed bump from the inactive position to the active position in response to the vehicle speed of the second vehicle approaching the actuatable speed bump exceeding a threshold speed.

7. The system of claim 1 wherein the communication unit is further configured to receive a wireless vehicle-to-x communication from a second vehicle traveling on the vehicle roadway and approaching the actuatable speed bump and wherein the controller is further configured to receive an input signal comprising data from the wireless vehicle-to-x communication from the second vehicle, the data indicative of a characteristic of the second vehicle, wherein the characteristic of the second vehicle comprises a vehicle speed and wherein the control signal is operative to control the actuator to move the element of the actuatable speed bump from the active position to the inactive position in response to the vehicle speed of the second vehicle approaching the actuatable speed bump failing to exceed a threshold speed.

8. The system of claim 1 wherein the communication unit is further configured to receive a wireless vehicle-to-x communication from a second vehicle traveling on the vehicle roadway and approaching the actuatable speed bump and wherein the controller is further configured to receive an input signal comprising data from the wireless vehicle-to-x communication from the second vehicle, the data indicative of a characteristic of the second vehicle, wherein the characteristic of the second vehicle comprises a vehicle type and wherein the control signal is operative to control the actuator to move the element of the actuatable speed bump from the inactive position to the active position in response to the vehicle type of the second vehicle approaching the actuatable speed bump comprising a private vehicle.

9. (canceled)

10. The system of claim 1 wherein the characteristic of the vehicle comprises a vehicle heading.

11. A method for controlling an actuatable speed bump for use with a vehicle roadway, the speed bump comprising an element and an actuator configured to move the element between inactive position and an active position, the method comprising:
receiving a wireless vehicle-to-x communication from a vehicle traveling on the vehicle roadway and approaching the actuatable speed bump;
receiving an input signal comprising data from the wireless vehicle-to-x communication, the data indicative of a characteristic of the vehicle; and
controlling the actuator to move the element of the actuatable speed bump between the inactive and active positions based on the characteristic of the vehicle;
wherein the characteristic of the vehicle comprises a vehicle type and wherein controlling the actuator to move the element of the actuatable speed bump between the inactive and active positions based on a characteristic of the vehicle comprises controlling the actuator to move the element of the actuatable speed bump from the active position to the inactive position in response to the vehicle type of the vehicle approaching the actuatable speed bump comprising a public safety vehicle.

12. (canceled)

13. The method of claim 11 wherein receiving the wireless vehicle-to-x communication comprises receiving the wireless vehicle-to-x communication at a roadside unit associated with the vehicle roadway.

14. The method of claim 11 further comprising broadcasting a wireless vehicle-to-x communication comprising data indicative of the element of the actuatable speed bump having the first position or the second position.

15. The method of claim 11 wherein the input signal comprises the wireless vehicle-to-x communication.

16. The method of claim 11 further comprising receiving a wireless vehicle-to-x communication from a second vehicle traveling on the vehicle roadway and approaching the actuatable speed bump, and receiving an input signal comprising data from the wireless vehicle-to-x communication received from the second vehicle, the data indicative of a characteristic of the second vehicle, wherein the characteristic of the second vehicle comprises a vehicle speed and wherein controlling the actuator to move the element of the actuatable speed bump between the inactive and active positions based on the characteristic of the vehicle comprises moving the element of the actuatable speed bump from the inactive position to the active position in response to the vehicle speed of the second vehicle approaching the actuatable speed bump exceeding a threshold speed.

17. The method of claim 11 further comprising receiving a wireless vehicle-to-x communication from a second vehicle traveling on the vehicle roadway and approaching the actuatable speed bump, and receiving an input signal comprising data from the wireless vehicle-to-x communication received from the second vehicle, the data indicative of a characteristic of the second vehicle, wherein the characteristic of the second vehicle comprises a vehicle speed and wherein controlling the actuator to move the element of the actuatable speed bump between the inactive and active positions based on the characteristic of the vehicle comprises moving the element of the actuatable speed bump from the active position to the inactive position in response to the vehicle speed of the second vehicle approaching the actuatable speed bump failing to exceed a threshold speed and the actuatable speed bump having an active position.

18. The method of claim 11 further comprising receiving a wireless vehicle-to-x communication from a second vehicle traveling on the vehicle roadway and approaching the actuatable speed bump, and receiving an input signal comprising data from the wireless vehicle-to-x communication received from the second vehicle, the data indicative of a characteristic of the second vehicle, wherein the characteristic of the second vehicle comprises a vehicle type and wherein controlling the actuator to move the element of the actuatable speed bump between the inactive and active positions based on the characteristic of the vehicle comprises moving the element of the actuatable speed bump from the inactive position to the active position in response to the vehicle type of the second vehicle approaching the actuatable speed bump comprising a private vehicle.

19. (canceled)

20. The method of claim 11 wherein the characteristic of the vehicle comprises a vehicle heading.

21. The system of claim 1 wherein the communication unit is part of the actuatable speed bump.

22. The system of claim 1 wherein the communication unit is part of the controller.

23. The method of claim 11 wherein receiving the wireless vehicle-to-x communication comprises receiving the wireless vehicle-to-x communication BSM at a communication unit associated with the actuatable speed bump.

24. The method of claim 11 wherein receiving the wireless vehicle-to-x communication comprises receiving the wireless vehicle-to-x communication BSM at a communication unit that is part of a controller for controlling the actuator of the actuatable speed bump.
